(19) United States
(12) Patent Application Publication
(10) Pub. No.: US 2008/0036917 A1
(43) Pub. Date: Feb. 14, 2008

(54) Methods and systems for generating and delivering navigatable composite videos

(76) Inventors: Mark Pascarella, Andover, MA (US); Patrick Donovan, Westford, MA (US); Dan O'Connor, Plaistow, NH (US)

Correspondence Address: ROPES & GRAY LLP;PATENT DOCKETING 39/41, ONE INTERNATIONAL PLACE, BOSTON, MA, 02110-2624, US

(21) Appl. No.: 11/784,993

(22) Filed: Apr. 9, 2007

Related U.S. Application Data
(60) Provisional application No. 60/790,182, filed on Apr. 7, 2006.
(60) Provisional application No. 60/872,736, filed on Dec. 4, 2006.

(51) Int. Cl. G06F 15/00; H04N 9/64

(52) U.S. Cl. 348/702; 725/42

(57) ABSTRACT

Systems and methods for generating a composite video having a plurality of video assets are provided. Systems may include storage having a plurality of video assets, a metadata generator, and a composite video generator. The metadata generator processes respective ones of the video assets to generate a metadata track representative of information that is descriptive of the content of the video asset. The composite video generator receives a plurality of metadata tracks and, in response, processes the associated video assets and the metadata tracks to generate a composite video asset having video data from the video assets. The composite video asset may have a metadata list panel that presents information representative of the metadata information as video data appearing within the composite video asset. The metadata list panel visually presents the sequence of video assets in the composite video asset.

### CROSS-REFERENCE TO RELATED APPLICATIONS

This application claims the benefit of U.S. Provisional Patent Application No. 60/790,182 filed Apr. 7, 2006 and entitled “System and Method for Enhanced Graphical Video Navigation” and U.S. Provisional Patent Application No. 60/872,736 filed Dec. 4, 2006 and entitled “Systems and Methods of Searching For and Presenting Video and Audio,” both of which are herein incorporated by reference.

### BACKGROUND OF THE INVENTION

As the popularity of the Internet and mobile devices such as cell phones and media players rises, the ability to easily access, locate, and interact with content available through these entertainment/information portals becomes more important. A popular way to consume video content is via playlists of video assets. Playlists may be user-generated, for example a playlist of music videos, or created by a media provider, for example a playlist of the top ten news stories of the clay. The ability to generate, navigate, and watch playlists typically requires a system equipped with a graphical user interface, software, and other systems to enable management of the video assets that make up a playlist. For example, the system can offer an interface with which a user can jump to a desired video asset by clicking on a corresponding link and must be able to locate and retrieve video assets in the playlist. Transferring a playlist to another media player (e.g., from a personal computer to a handheld media player) requires compatible software capable of playlist management as well, which limits the media players and/or interfaces with which a user can access a desired playlist. A need remains for a method of generating playlists of video assets that are more universally compatible.

### SUMMARY OF THE INVENTION

Methods and systems of generating and delivering composite videos having a plurality of video assets are provided. A composite video may be a single asset formed from the plurality of video assets and having graphics which facilitate navigation of the assets. The composite video may also include advertising that may be related to contents of the video assets. Metadata corresponding the plurality of video assets is used to facilitate delivery of the composite videos. In particular, metadata may be used to enable selection of video assets for inclusion, for generating the video and graphics presented in the composite video, and for selecting or locating the advertising included in the composite video. The graphics included in the composite video may facilitate navigation of the composite video using generic playback devices, namely ones capable of at least fast-forward and rewind functions. Such a system provides great utility as it facilitates the broad distribution of video assets.

According to one aspect of the invention, systems and methods for generating a composite video having a plurality of video assets are provided. Systems may include storage having a plurality of video assets, a metadata generator, and a composite video generator. The metadata generator processes respective ones of the video assets to generate a metadata track representative of information that is descriptive of the content of the video asset. The composite video generator receives a plurality of metadata tracks and, in response, processes the associated video assets and the metadata tracks to generate a composite video asset having video data from the video assets. The composite video asset may have a metadata list panel that presents information representative of the metadata information as video data appearing within the composite video asset. The metadata list panel visually presents the sequence of video assets in the composite video asset.

According to another aspect of the invention, methods and systems for delivering video assets are provided. Methods may include the step of providing a plurality of video assets and for respective ones of the video asset, metadata tracks representative of information about a respective video asset. The video assets are representative of video content of the type capable of being displayed on a video player. A user may select from the plurality of video assets to identify a set of video assets to be joined sequentially into a composite video. The selected video assets may be processed as a function of their respective metadata tracks to generate a composite video. The composite video has a metadata list panel that presents metadata information as video data appearing within a composite video that includes video data from the video asset. The metadata list panel visually presents the sequence of video assets in the composite video. In one embodiment, a plurality of advertisement videos representative of video content for promoting a good or service are provided, where the advertisement videos are capable of display on a video player. At least one advertisement video may be joined within the sequence of video assets in the composite video.

### BRIEF DESCRIPTION OF THE DRAWINGS

In the detailed description which follows, reference will be made to the attached drawings, in which:

FIG. 1 depicts an illustrative system capable of providing video to users via multiple platforms;

FIGS. 2A and 2B depict illustrative abstract representations of formats for video and metadata corresponding to the video;

FIG. 3 depicts an illustrative system for sharing video within a community;

FIG. 4 depicts an illustrative screenshot of a user interface for interacting with video;

FIG. 5 depicts an illustrative abstract representation of a sequence of frames of an encoded video file;

FIG. 6 depicts an illustrative system capable of generating composite videos having a plurality of video assets, where video assets may be videos or segments of videos;

FIGS. 7A and 7B depict illustrative screenshots of a composite video, such as those generated by the system depicted in FIG. 6;

FIGS. 8A and 8B depict illustrative screenshots with which a user may indicate user input; and

FIG. 9 depicts a flowchart for an illustrative method for delivering a composite video asset having a plurality of video assets, which may be implemented by the system depicted in FIG. 6.

### DETAILED DESCRIPTION

The invention includes methods and systems for generating and delivering composite videos having a plurality of video assets. The following illustrative embodiments describe systems and methods for processing and presenting video content. The inventions disclosed herein may also be used with other types of media content, such as audio or other electronic media.

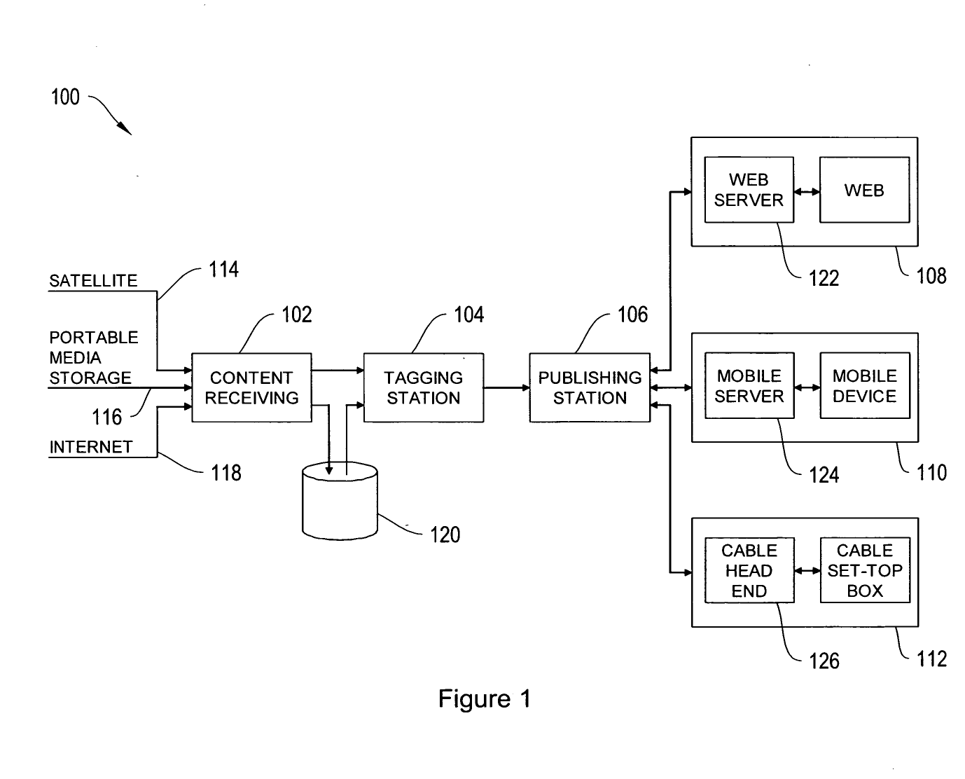

FIG. 1 depicts an illustrative system 100 that is capable of providing video to users via multiple platforms. The system 100 receives video content via a content receiving system 102 that transmits the video content to a tagging station 104 capable of generating metadata that corresponds to or is otherwise associated with the video content to enhance and facilitate a user's experience of the video content. A publishing station 106 prepares the video content and corresponding metadata for transmission to a platform, where the preparation performed by the publishing station 106 may vary according to the type of platform. FIG. 1 depicts three exemplary types of platforms: the Internet 108, a wireless device 110 and a cable television system 112.

The content receiving system 102 may receive video content via a variety of methods. For example, video content may be received via satellite 114, imported using some form of portable media storage 116 such as a DVD or CD, or downloaded from or transferred over a network such as the Internet 118, for example by using FTP (file transfer protocol). Other methods and systems for delivery of content to content receiving system 102 may also be used. Video content broadcast via satellite 114 may be received by a satellite dish in communication with a satellite receiver or set-top box. A server may track when and from what source video content arrived and where the video content is located in storage. Portable media storage 116 may be acquired from a content provider and inserted into an appropriate playing device to access and store its video content. A user may enter information about each file such as information about its contents. The content receiving system 102 may receive a signal that indicates that a website monitored by the system 100 has been updated. In response, the content receiving system 102 may acquire the updated information using FTP.

In the embodiment 100 depicted in FIG. 1, the content receiving system 102 is shown as an element of a functional block diagram. In practice, the content receiving system 102 may be a conventional workstation computer system that has been programmed to operate as the content receiving system 102. The workstation may have a network interface, a satellite interface, and/or a memory interface that allows the system 102 to store and/or access content or a data storage device, such as a hard drive or other computer memory device.

Video content may include broadcast content, entertainment, news, weather, sports, music, music videos, television shows, and/or movies. Exemplary media formats include MPEG standards, Flash Video, Real Media, Real Audio, Audio Video Interleave, Windows Media Video, Windows Media Audio, Quicktime formats, and any other digital media format. After being receiving by the content receiving system 102, video content may be stored in storage 120, such as Network-Attached Storage (NAS) or directly transmitted to the tagging station 104 without being locally stored. Stored content may be periodically transmitted to the tagging station 104. For example, news content received by the content receiving system 102 may be stored, and every 24 hours the news content that has been received over the past 24 hours may be transferred from storage 120 to the tagging station 104 for processing.

The tagging station 104 processes video to generate metadata that corresponds to or is associated with the video. The metadata may be information, commentary, hypertext links, audio narratives, additional video, or any other information a user may wish to associate with the video. The metadata may enhance an end user's experience of video content by describing a video, providing markers or pointers for navigating or identifying points or segments within a video, or generating playlists of videos or video segments. In one embodiment, metadata identifies segments of a video file that may aid a user to locate and/or navigate to a particular segment within the video file. Metadata may include the location and description of the contents of a segment within a video file. The location of a segment may be identified by a start point of the segment and a size of the segment, where the start point may be a byte offset of an electronic file or a time offset from the beginning of the video, and the size may be a length of time or the number of bytes within the segment. In addition, the location of the segment may be identified by an end point of the segment. The contents of the segment may be described through a segment name, a description of the segment, tags such as keywords or short phrases associated with the contents. Metadata may also include information that helps a presentation device decode a compressed video file. For example, metadata may include the location of the I-frames or key frames within a video file necessary to decode the frames of a particular segment for playback. Metadata may also designate a frame that may be used as an image that represents the contents of a segment, for example as a thumbnail image. The tagging station 104 may also generate playlists of segments that may be transmitted to users for viewing, where the segments may be excerpts from a single received video file, for example highlights of a sports event, or excerpts from multiple received video files. The segments of a playlist may be selected by an operator interacting with the tagging station 104 (e.g., by selecting segments of a sporting event that the operator considers the highlights) and/or automatically based on a predetermined method (e.g., the most viewed segments of the day). Metadata may be stored as an XML (Extensible Markup Language) file separate from the corresponding video file and/or may be embedded in the video file itself. Metadata may be generated by a user watching or listening to the content being tagged while using a software program on a personal computer to generate the metadata or automatically by a processor configured to recognize particular segments of video.

The publishing station 106 processes and prepares the video files and metadata, including any segment identifiers or descriptions, for transmittal to various platforms. Video files may be converted to other formats that may depend on the platform. For example, video files stored in storage 120 or processed by the tagging station 104 may be formatted according to an MPEG standard, such as MPEG-2, which may be compatible with cable television 112. MPEG video may be converted to flash video for transmittal to the Internet 108 or 3 GP for transmittal to mobile devices 110. Other formats may be selected and the format or formats selected may depend upon the application.

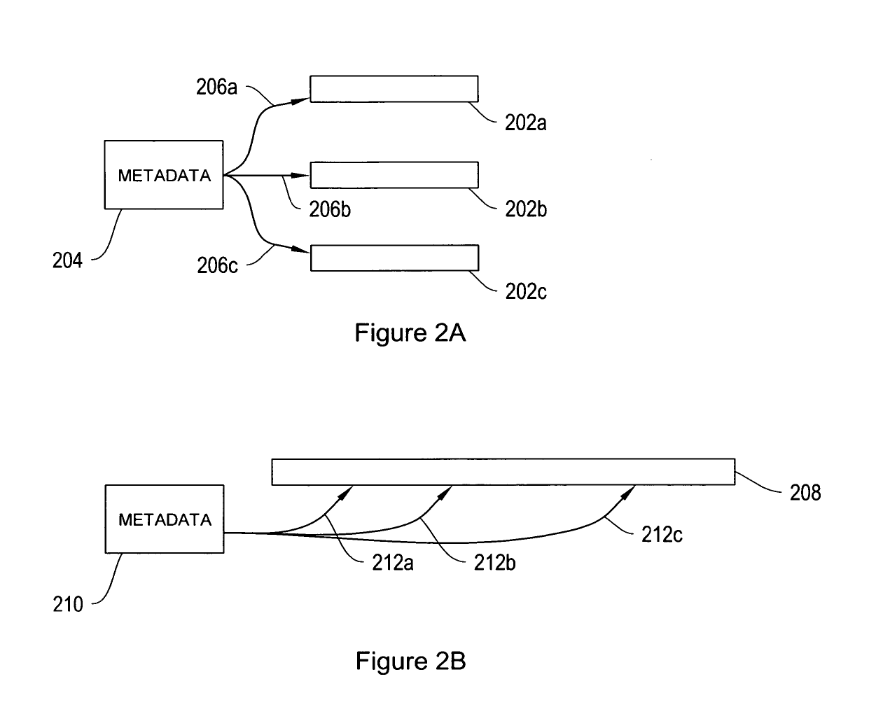

Video files may be converted to multiple video files, each corresponding to a different video segment, or may be merged to form one video file. FIG. 2A depicts an illustrative example of how video and metadata are organized for transmittal to the Internet 108 from the publishing station 106. Video segments are transmitted as separate files 202a, 202b, and 202c, with an accompanying playlist transmitted as metadata 204 that includes pointers 206a, 206b, and 206c to each file containing a segment in the playlist. FIG. 2B depicts an illustrative example of how video and metadata are organized for transmittal to a cable television system 112 from the publishing station 106. Video segments, that may originally have been received from separate files or sources, form one file 208, and are accompanied by a playlist transmitted as metadata 210 that includes pointers 212a, 212b, and 212c to separate points within the file 208 that each represent the start of a segment. The publishing station 106 may also receive video and metadata organized in one form from one of the platforms 108, 110, and 112, for example that depicted in FIG. 2A, and re-organize the received video and metadata into a different form, for example such as that depicted in FIG. 2B, for transmittal to a different platform. Each type of platform 108, 110, or 112 has a server, namely a web server 122, mobile server 124, or cable head end 126, respectively, that receives video and metadata from the publishing station 106 and can transmit the video and/or metadata to a presentation device in response to a request for the video, a video segment, and/or metadata.

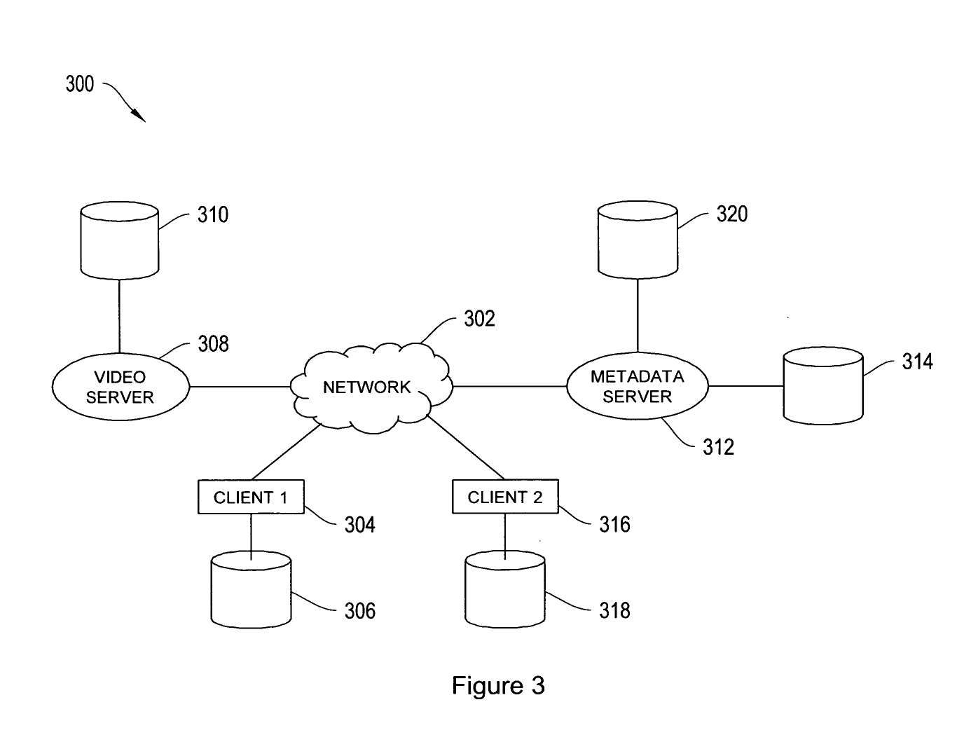

FIG. 3 depicts one illustrative system 300 for sharing video within a community of users over a network 302, such as the Internet. A first user at a first client device 304 and a second user at a second client device 316 may each generate metadata that corresponds to video that is either stored locally in storage 306 and 318, respectively, or available over the network, for example from a video server 308, similar to the web server 122 depicted in FIG. 1, in communication with storage 310 that stores video. Other users, though not depicted, may also be in communication with the network 302 and capable of generating metadata. Metadata generated by users may be made available over the network 302 for use by other users and stored either at a client device, e.g., storage 306 and 318, or in storage 320 in communication with a metadata server 312. A web crawler may automatically browse the network 302 to create and maintain an index 314 of metadata corresponding to video available over the network 302, which may include user-generated metadata and metadata corresponding to video available from the video server 308. The metadata server 312 may receive requests over the network 302 for metadata that is stored at storage 320 and/or indexed by the metadata index 314.

In one embodiment, metadata is stored in at least two different formats. One format is a relational database, such as an SQL database, to which metadata may be written when generated. The relational database may be include tables organized by user and include, for each user, information such as user contact information, password, and videos tagged by the user and accompanying metadata. Metadata from the relational database may be exported periodically as an XML file to a flat file database, such as an XML file. The flat file database may be read, searched, or index, e.g. by an information retrieval application programming interface such as Lucene. Multiple copies of databases may each be stored with corresponding metadata servers, similar to the metadata server 312, at different colocation facilities that are synchronized.

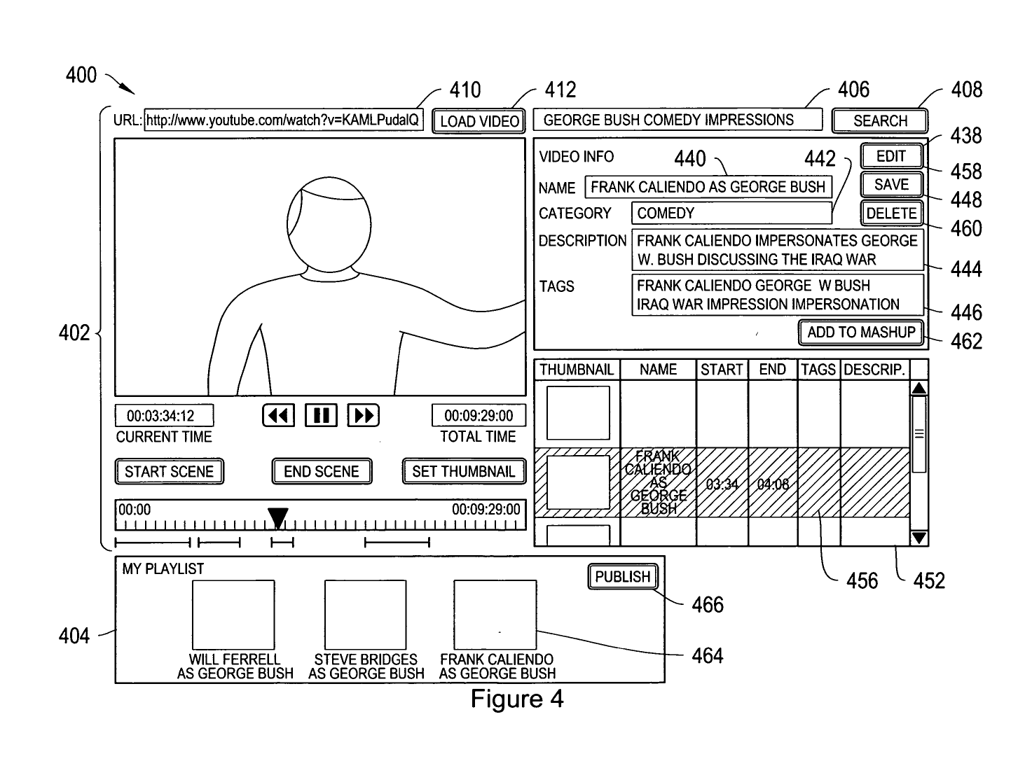

FIG. 4 depicts an illustrative screenshot 400 of a user interface for interacting with video. A tagging station 402 allows a user to generate metadata that designates segments of video available over a network such as the Internet. The user may add segments of video to an asset bucket 404 to form a playlist, where the segments may have been designated by the user and may have originally come from different sources. The user may also search for video and video segments available over the network by entering search terms into a search box 406 and clicking on a search button 408. A search engine uses entered search terms to locate video and video segments that have been indexed by a metadata index, similar to the metadata index 314 depicted in FIG. 3. For example, a user may enter the search terms “George Bush comedy impressions” to locate any video showing impersonations of President George W. Bush. The metadata index may include usernames of users who have generated metadata, allowing other users to search for video associated with a specific user. Playback systems capable of using the metadata generated by the tagging station 402 may be proprietary. Such playback systems and the tagging station 402 may be embedded in webpages, allowing videos to be viewed and modified at webpages other than those of a provider of the tagging station 402.

Using the tagging station 402, a user may enter the location, e.g. the uniform resource locator (URL), of a video into a URL box 410 and click a load video button 412 to retrieve the video for playback in a display area 414. The video may be an externally hosted Flash Video file or other digital media file, such as those available from YouTube, Metacafe, and Google Video. For example, a user may enter the URL for a video available from a video sharing website, such as http://www.youtube.com/watch?v=kAMIPudalQ, to load the video corresponding to that URL. The user may control playback via buttons such as rewind 416, fast forward 418, and play/pause 420 buttons. The point in the video that is currently playing in the display area 414 may be indicated by a pointer 422 within a progress bar 424 marked at equidistant intervals by tick marks 426. The total playing time 428 of the video and the current elapsed time 430 within the video, which corresponds to the location of the pointer 422 within the progress bar 424, may also be displayed.

To generate metadata that designates a segment within the video, a user may click a start scene button 432 when the display area 414 shows the start point of a desired segment and then an end scene button 434 when the display area 414 shows the end point of the desired segment. The metadata generated may then include a pointer to a point in the video file corresponding to the start point of the desired segment and a size of the portion of the video file corresponding to the desired segment. For example, a user viewing a video containing the comedian Frank Caliendo performing a variety of impressions may want to designate a segment of the video in which Frank Caliendo performs an impression of President George W. Bush. While playing the video, the user would click the start scene button 432 at the beginning of the Bush impression and the end scene button 434 at the end of the Bush impression. The metadata could then include either the start time of the desired segment relative to the beginning of the video, e.g., 03:34:12, or the byte offset within the video file that corresponds to the start of the desired segment and a number representing the number of bytes in the desired segment. The location within the video and length of a designated segment may be shown by a segment bar 436 placed relative to the progress bar 424 such that its endpoints align with the start and end points of the designated segment.

To generate metadata that describes a designated segment of the video, a user may enter into a video information area 438 information about the video segment such as a name 440 of the video segment, a category 442 that the video segment belongs to, a description 444 of the contents of the video segment, and tags 446, or key words or phrases, related to the contents of the video segment. To continue with the example above, the user could name the designated segment “Frank Caliendo as Pres. Bush” in the name box 440, assign it to the category “Comedy” in the category box 442, describe it as “Frank Caliendo impersonates President George W. Bush discussing the Iraq War” in the description box 444, and designate a set of tags 446 such as “Frank Caliendo George W Bush Iraq War impression impersonation.” A search engine may index the video segment according to any text entered in the video information area 438 and which field, e.g. name 440 or category 442, the text is associated with. A frame within the segment may be designated as representative of the contents of the segment by clicking a set thumbnail button 450 when the display area 414 shows the representative frame. A reduced-size version of the representative frame, e.g. a thumbnail image such as a 140×100 pixel JPEG file, may then be saved as part of the metadata.

When finished with entering information, the user may click on a save button 448 to save the metadata generated, without necessarily saving a copy of the video or video segment. Metadata allows a user to save, upload, download, and/or transmit video segments by generating pointers to and information about the video file, and without having to transmit the video file itself. As generally metadata files are much smaller than video files, metadata can be transmitted much faster and use much less storage space than the corresponding video. The newly saved metadata may appear in a segment table 452 that lists information about designated segments, including a thumbnail image 454 of the representative frames designated using the set thumbnail button 450. A user may highlight one of the segments in the segment table 452 with a highlight bar 456 by clicking on it, which may also load the highlighted segment into the tagging station 402. If the user would like to change any of the metadata for the highlighted segment, including its start or end points or any descriptive information, the user may click on an edit button 458. The user may also delete the highlighted segment by clicking on a delete button 460. The user may also add the highlighted segment to a playlist by clicking on an add to mash-up button 462 which adds the thumbnail corresponding to the highlighted segment 464 to the asset bucket 404. To continue with the example above, the user may want to create a playlist of different comedians performing impressions of President George W. Bush. When finished adding segments to a playlist, the user may click on a publish button 466 that will generate a video file containing all the segments of the playlist in the order indicated by the user. In addition, clicking the publish button 466 may open a video editing program that allows the user to add video effects to the video file, such as types of scene changes between segments and opening or closing segments.

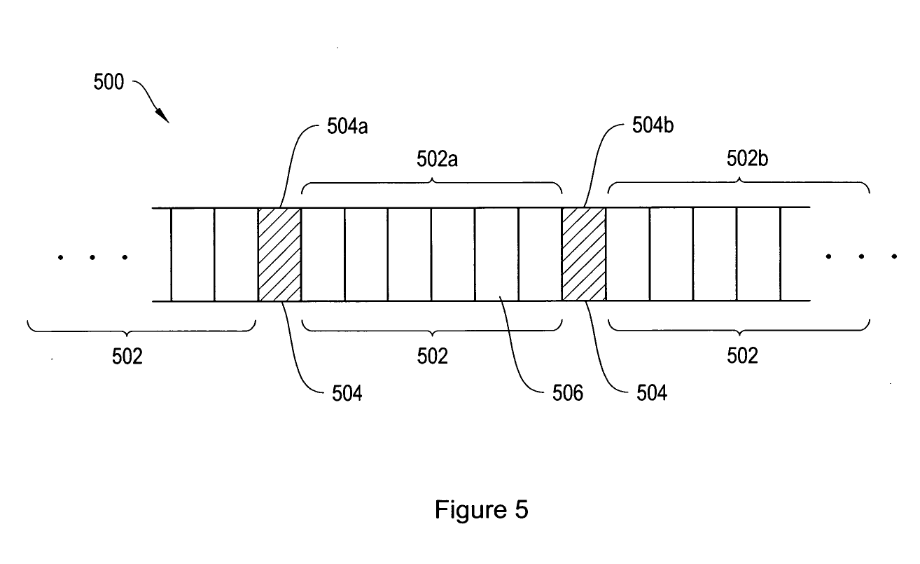

Metadata generated and saved by the user may be transmitted to or available to other users over the network and may be indexed by the metadata index of the search engine corresponding to the search button 408. When another user views or receives metadata and indicates a desire to watch the segment corresponding to the viewed metadata, a playback system for the other user may retrieve just that portion of a video file necessary for the display of the segment corresponding to the viewed metadata. For example, the hypertext transfer protocol (http) for the Internet is capable of transmitting a portion of a file as opposed to the entire file. Downloading just a portion of a video file decreases the amount of time a user must wait for the playback to begin. In cases where the video file is compressed, the playback system may locate the key frame (or I-frame or intraframe) necessary for decoding the start point of the segment and download the portion of the video file starting either at that key frame or the earliest frame of the segment, whichever is earlier in the video file. FIG. 5 depicts an illustrative abstract representation 500 of a sequence of frames of an encoded video file. In one embodiment, the video file is compressed such that each non-key frame 502 relies on the nearest key frame 504 that precedes it. In particular, non-key frames 502a depend on key frame 504a and similarly non-key frames 502b depend on key frame 504b. To decode a segment that starts at frame 506, for example, a playback system would download a portion of the video file starting at key frame 504a. The location of the necessary key frames and/or the point in a video file at which to start downloading may be saved as part of the metadata corresponding to a video segment.

The user may also during playback of a video or video segment mark a point in the video and send the marked point to a second user so that the second user may view the video beginning at the marked point. Metadata representing a marked point may include the location of the video file and a pointer to the marked point, e.g. a time offset relative to the beginning of the video or a byte offset within the video file. The marked point, or any other metadata, may be received on a device of a different platform than that of the first user. For example, with reference to FIG. 1, the first user may mark a point in a video playing on a computer connected to the Internet, such as the Internet 108, then transmit the marked point via the publishing station 106 to a friend who receives and plays back the video, starting at the marked point, on a mobile phone, such as the wireless device 110. Marked points or other metadata may also be sent between devices belonging to the same user. For example, a user may designate segments and create playlists on a computer connected to the Internet, to take advantage of the user interface offered by such a device, and send playlists and marked points indicating where the user left off watching a video to a mobile device, which is generally more portable than a computer.

In general, a device on a platform 108, 110 or 112 depicted in FIG. 1 may be in communication with a network similar to the network 302 depicted in FIG. 2 to allow users in communication with the network 302 access to video and metadata generated by the system 100 of FIG. 1 and to transmit video and metadata across platforms. The user interface depicted in FIG. 4 may be used on any of the platforms 108, 110, and 112 of FIG. 1. In addition, simplified versions of the user interface, for example a user interface that allows only playback and navigation of playlists or marked points, may be used on platforms having either a small display area, e.g. a portable media player or mobile phone, or tools for interacting with the user interface with relatively limited capabilities, e.g., a television remote.

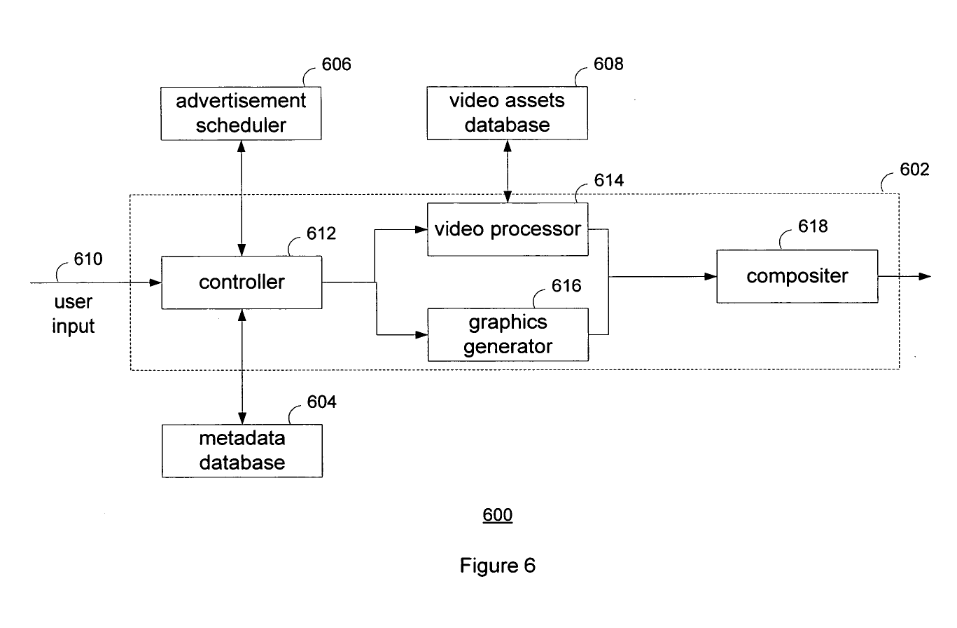

The video assets generated using the systems and methods described above, as well as music videos and other video assets may be combined into a composite video using the system of FIG. 6. FIG. 6 depicts an illustrative system 600 capable of generating composite videos having a plurality of video assets, where video assets may be videos or segments of videos. The system 600 may be part of the publishing station 106 of FIG. 1. The system 600 includes a composite video generator 602 in communication with a metadata generator 604 (e.g., the tagging station 104 of FIG. 1), an optional advertisement scheduler 606, and database 608 (or other storage device) and which can generate composite videos based on user input 610. User input 610 indicates a playlist of video assets and may be transmitted from a user via a media device (e.g., a device on platform 108, 110, or 112 of FIG. 1) or from a playlist generator (e.g., the tagging station 104 of FIG. 1). In some embodiments, the user input 610 indicates criteria for ads to be included in the generated composite videos by the advertisement scheduler 606, which is described further below.

Based on the user input 610, the composite video generator 602 locates and retrieves the video assets indicated by the user input 610 from the database 608 using metadata from the metadata generator 604, where each video asset may have an associated metadata track including information representative of the contents of the video asset. The metadata may be transmitted directly from the metadata generator 604 or via a storage device storing metadata from the metadata generator 604. The video assets may be transmitted directly from the database 608 or via an index of locations of video assets. The advertisement scheduler 606 transmits data indicating when and where to place the ads within the composite video to the composite video generator 602. The advertisement scheduler 606 may include an ad server which provides ads (e.g., banner ads or video ads selling or promoting a good or service), or data indicating where such ads are located to the composite video generator 602. In some embodiments, the ad server selects ads that are targeted based on criteria associated with the end consumer. To this end, the ad server may select ads to provide to the generator 602 as a function of the metadata of the associated metadata tracks provided by the metadata generator 604.

In some embodiments, the composite video generator 602 includes a controller 612, a video processor 614, a graphics generator 616, and a compositer 618. The controller 612 generates a timeline of assets, graphics, and/or ads based on the user input 610 and using data from the advertisement scheduler 606 and the metadata generator 604. For example, the user input 610 may indicate a playlist of video assets. The controller 612 receives from metadata generator 604 metadata for the video assets including a location of each video asset (e.g., a time stamp of a video file at which the video asset begins), a length of each video asset (e.g., a start time and an end time of the video asset), and data describing the contents of the each video asset (e.g., a title, description, and/or keywords) which may be displayed as graphics within the composite video. From the advertisement scheduler 606, the controller 612 receives ads or data indicating ad locations and criteria guiding ad placement within the composite video. Exemplary criteria includes requiring a video ad to play between each video asset or every other video asset or every 10 minutes or some other predetermined length of time, an order in which to present video ads or banner ads, and where to place ads on a presentation screen (e.g., the corner of the screen or along the length of the screen). Criteria guiding ad placement may alternatively or additionally be received from the user input 610. The controller 612 may request ads from the advertisement scheduler 606 based on the user input 610 and/or on metadata tracks associated with the video assets indicated by the user input 610. From the metadata and ad information received from the metadata generator 604 and the advertisement scheduler 606, the controller 612 generates a sequence of time stamps for the composite video and corresponding events that occur at the times indicated by the time stamps, such as a video asset, ad, or graphics to be displayed in the composite video.

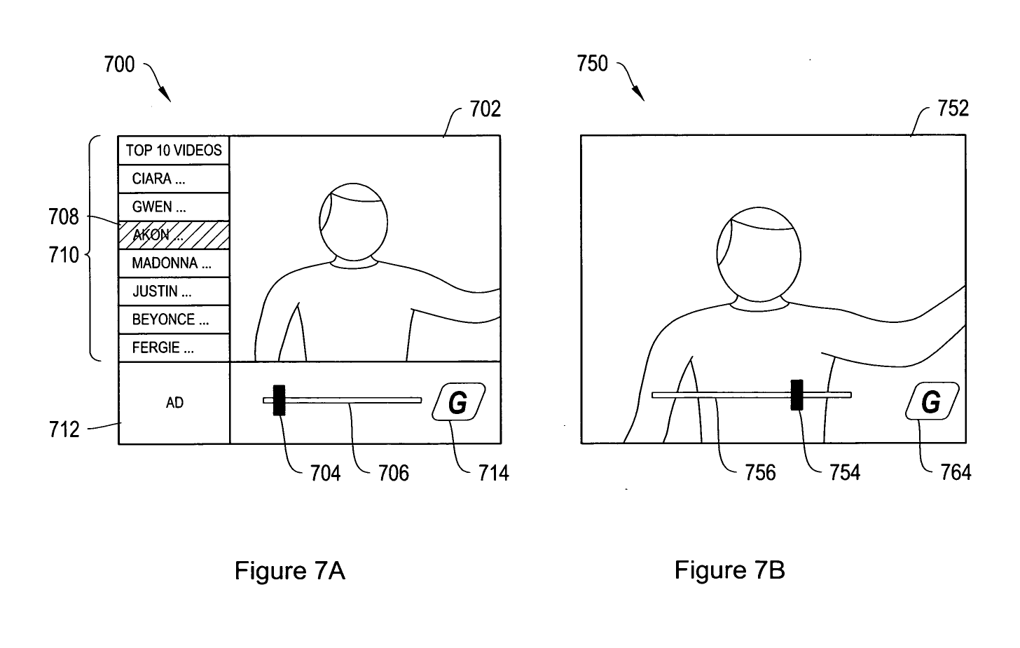

The controller 612 transmits the timeline and metadata to a video processor 614 and a graphics generator 616 for processing. Based on the metadata, the video processor 614 retrieves video assets, which may include video ads, from the database 608 and concatenates the retrieved video assets into a single video according to the timeline. It is well known in the art how to process multiple video files into one video file that presents the contents of the multiple video files consecutively. The graphics generator 616 generates graphics for the composite video based on the metadata and timeline received from the controller 612. In particular, the graphics generator can generate graphics that correspond to the single video generated by video processor 614 for overlaying on top of the single video. Exemplary graphics include metadata list panels, or visual playlists, that highlight a playlist item that corresponds to a video asset, visual indicators indicating the current temporal location within a video asset, and ads. In particular, the graphics generator 616 may include a visual indicator tool for generating visual indicators such as a progress mark, i.e., a visually perceptible mark having a characteristic that changes function as a function of temporal progress of the video asset. Exemplary progress marks may be generated by a progress mark generator and are described further below with respect to FIGS. 7A and 7B. Banner ads may be generated by a banner ad generator capable of providing an area or space within the composite video for receiving and presenting a banner ad.

The compositer 618 receives the single video from video processor 614 and graphics from graphics generator 616 and generates a composite video of both. In particular, the composite video can be a single file, such as an MPEG encoded file, in which the video assets play consecutively with corresponding graphics overlaid onto the video assets.

FIGS. 7A and 7B depict illustrative screenshots 700 and 750, respectively, of a composite video, such as those generated by the system 600 of FIG. 6. An exemplary composite video may have an introductory video or frame as its first video asset, such as a title video or frame for the playlist of the composite video, followed by the video assets of the playlist. The introductory video may be added by a frame processor that is part of the video processor 614 of FIG. 6. The introductory video or frame may include advertising. Each video asset of the playlist may be presented in full-screen mode, i.e., displayed within the entire display area or partial-screen mode, i.e., within a display area of the screen surrounded by information relating to the composite video, such as a progress bar or metadata list panel that visually presents the sequence of video assets in the playlist, and ads. In some embodiments, the beginning and/or end portions of a video asset may be presented in partial-screen mode while the rest of the video asset is presented in full-screen mode. Interstitial video ads, i.e., ads that play between other video assets of the composite video, may also be presented in either full-screen or partial-screen mode, but are not necessarily listed in any displayed playlist. The transitions between full-screen and partial-screen modes may be facilitated by a scaling processor capable of processing a video asset to alter the visual scale of the video asset as a function of time, which may be based on instructions from a controller, such as the controller 612 of FIG. 6.

FIG. 7A depicts illustrative screenshot 700 of a video asset of the composite video in partial-screen mode. The video asset is presented in a display area 702 surrounded by graphics generated by a graphics generator (e.g., graphics generator 616 of FIG. 6). In this embodiment, the video asset has been combined with the metadata representing the playlist 710 so that the composite video, which may be for example an MPEG file, presents a video image that includes the content of the video asset integrated with the image of the playlist. The current point in time within the video asset is indicated by a visual indicator which in this example is a thumb 704 along a progress bar 706. The item 708 of the playlist 710 (or metadata list panel) corresponding to the presented video asset may be highlighted, where information included in the item 708 may be based on metadata from a metadata generator (e.g., metadata generator 604 of FIG. 6). An ad 712 may be displayed adjacent to the video asset and its accompanying graphics. A logo 714 may be displayed that represents a provider of the composite video generator or an advertiser who may be sponsoring the composite video. An introductory frame or video may also be presented in partial-screen mode.

FIG. 7B depicts illustrative screenshot 750 of a video asset of the composite video in full-screen mode. The display area 752 in which the video asset is presented substantially covers the screen area available. Graphics presented during partial-screen mode may remain during full-screen mode, such as the thumb 754, progress bar 756, and logo 764, and may be partially transparent to allow the underlying video asset to be seen. Illustrative images of screenshots are disclosed in U.S. Provisional Application Ser. No. 60/790,182 filed Apr. 7, 2006 and entitled “System and Method for Enhanced Graphical Video Navigation.”

Graphics of the composite video may include visual indicators to indicate the current location within the composite video. For example, during playback, rewind, or fast-forward of the composite video file, the playlist 710, the ad 712, the progress bar 706, and/or the logo 714 may remain substantially unchanged for a period of time, even as the composite video switches between viewing modes such as those depicted in FIGS. 7A and 7B, allowing a viewer to parse the information imparted by the graphics that remain substantially unchanged. For example, while fast-forwarding the composite video, the viewer may observe the thumb's progress along the progress bar 706 and/or the currently highlighted item of the playlist 710 to track the current location within the composite video. In addition, some or all of the substantially unchanged graphics may exhibit a color change to represent location to the viewer. For example, the thumb 704 and 754 may be green during a middle portion of a video asset, and then progressively turn yellow then red as it approaches the end of the video asset. Other graphics may also exhibit color changes, such as the logo 714 and 764 or progress bar 706 and 756. The ad 712 may also remain substantially unchanged for a period of time to allow viewing of the ad even during rewind or fast-forward of the composite video. In some embodiments, a counter displaying the elapsed or remaining time for the currently presented video asset or the composite video may be displayed to indicate the temporal location of the presented video data.

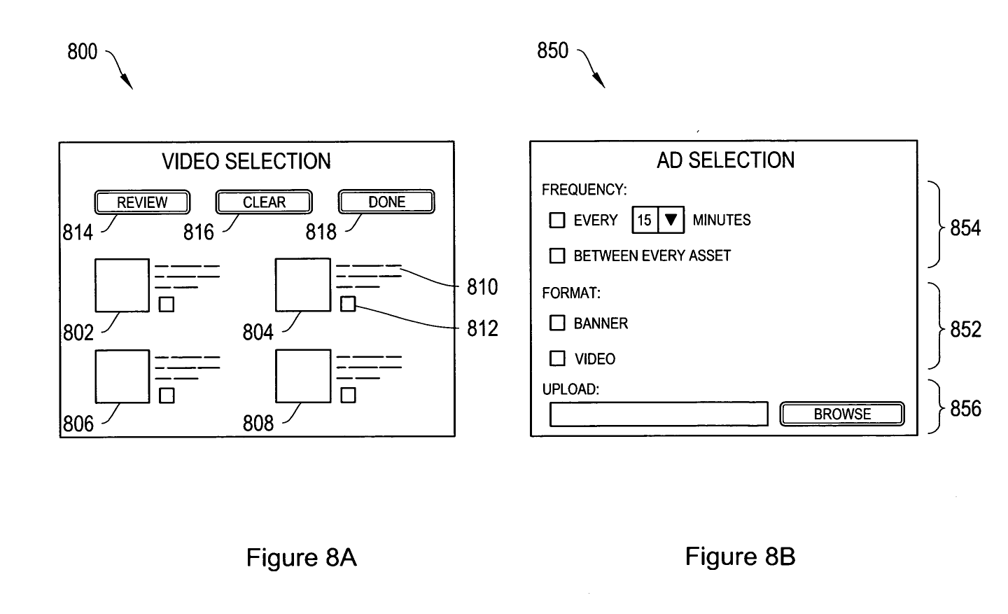

FIGS. 8A and 8B depict illustrative screenshots 800 and 850, respectively, which can facilitate the delivery of video assets. In particular, the screenshots 800 and 850 allow a user to indicate user input, such as user input 610 of FIG. 6. In screenshot 800, a listing of video assets 802, 804, 806, and 808 selectable by the user for inclusion in a composite video is presented. More video assets may be available but are not depicted for the sake of clarity. The listing of video assets may be the result of a metadata-based search for video assets, as described above with respect to FIGS. 3 and 4. Each video asset may be accompanied by a description 810, such as a title, keywords, artist, or other descriptive elements, which may be provided from a metadata generator (e.g., the metadata generator 604 of FIG. 6). Each video asset may be accompanied by a box 812 or other interface mechanism with which the user may select the video asset for inclusion in a composite video and indicate the desired ordering of the selected video assets. The user may also review the ordering and selections by indicating the review button 814, clear the selections made by indicating the clear button 816, or indicate that the selection process is finished by indicating the done button 818, at which point screenshot 850 may be displayed.

In screenshot 850, a listing of options for criteria for presenting ads is presented. For example, the user may indicate the types of ads desired, such as banner ads or interstitial video ads, using area 852. The user may indicate the frequency with which ads are presented using area 854. The user may also upload a video or image file containing a desired ad at area 856. Screenshots 800 and 850 may be useful for a commercial or other entity desiring a media vehicle for delivering advertising, allowing the entity to sponsor a composite video that may be customized according to the desires of the entity. The composite video generated is easily transferred and does not require proprietary systems or software to present, allowing the entity to easily display the composite video on its own platforms such as a website. The entity may also search for and/or select video assets related to the products and/or services it is advertising. For example, Nike may have Tiger Woods as a spokesperson, and would like the create a composite video of video assets containing Tiger Woods sinking golf holes in which Nike ads would be interspersed.

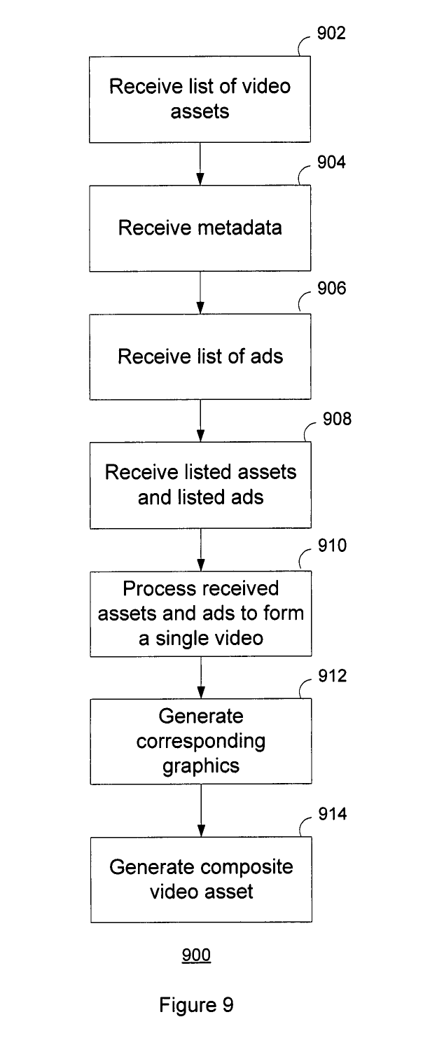

FIG. 9 depicts a flowchart 900 for an illustrative method for delivering a composite video asset having a plurality of video assets, which may be implemented by the system 600 of FIG. 6. At step 902, a list of video assets is received, which help determine the content displayed in the composite video asset. The list may be received by a composite video generator (e.g., composite video generator 602) via user input, such as user input 610. At step 904, metadata corresponding to the assets in the received list may be received, for example, from metadata generator 604. At step 906, a list of advertisements is received, where the advertisements may be selected according to the user input 610 or based on the metadata received at step 904. For example, a video asset may be a music video having metadata that includes the artist and album associated with the music video. One of the advertisements on the list of advertisements received at step 906 may then be promoting or selling the associated album or other albums or paraphernalia of the artist. The retrieval and processing of metadata and selection of advertisements may be performed by a controller such as the controller 612.

At step 908, video assets of the lists of video assets and advertisements may be received, for example, from database 608 and/or advertisement scheduler 606. At steps 910 and 912, the received video assets are processed to form a composite asset and to generate graphics, respectively, according to the received lists, which may be performed by video processor 614 and graphics generator 616, respectively. The composite asset formed at step 910 and the graphics generated at step 912 may be combined to form a composite video asset at step 914, which may be performed by compositer 618. In practice, one or more steps shown in process 900 may be combined with other steps, performed in any suitable order, performed in parallel (e.g., simultaneously or substantially simultaneously), or removed.

Applicants consider all operable combinations of the embodiments disclosed herein to be patentable subject matter.

What is claimed is:

1. A system for generating a composite video having a plurality of video assets, comprising
storage having a plurality of video assets,
a metadata generator for processing respective ones of the video assets to generate a metadata track representative of information that is descriptive of the content of the video asset, and
a composite video generator that receives a plurality of metadata tracks, and responsive thereto, processes the associated video assets and the metadata tracks to generate a composite video asset having a metadata list panel that presents information representative of the metadata information as video data appearing within a composite video that includes video data from the video assets, whereby the sequence of video assets in the composite video is visually presented by the metadata list panel.

2. The system according to claim 1, wherein the composite video generator further comprises
a controller for controlling generation of the composite video asset.

3. The system according to claim 2, wherein the composite video generator further comprises
a visual indicator tool controlled by the controller for applying to a respective video asset a visual indicator representative of a temporal location within the video asset.

4. The system according to claim 3, wherein the visual indicator tool comprises,
a progress mark generator capable of overlaying onto a plurality of scenes in a video asset a visually perceptible mark having a characteristic that changes as a function of temporal progress of the video asset.

5. The system according to claim 4, wherein the progress mark is selected from the group consisting of a progress bar, a thumb, a counter, and a color code.

6. The system according to claim 1, further comprising
an advertisement scheduler for inserting within the composite video data representative of an advertisement.

7. The system according to claim 2, wherein the composite video generator further comprises
a scaling processor controlled by the controller for processing a video asset to alter a visual scale of the video asset as a function of time to generate a composite video wherein the scale of a video asset changes during play.

8. The system according to claim 1, wherein the composite video generator further comprises
a frame processor for adding an introductory frame to the composite video wherein the introductory frame includes an advertisement and a metadata list panel.

9. The system according to claim 2, wherein the composite video generator further comprises
a banner ad generator controlled by the controller and capable of providing a space within the composite video for receiving a banner ad.

10. The system according to claim 1, further comprising
an ad server for providing to the video data processor a video asset having content for promoting a good or service.

11. The system according to claim 10, wherein
the ad server selects a video asset having content for selling a good or service as a function of the metadata associated with at least one of the video assets selected for inclusion in the composite video.

12. The system according to claim 1, further comprising
a controller for regulating the selection of video assets being combined.

13. The system according to claim 12, wherein the regulator includes
means for associating a selected video asset with an advertisement video, whereby the selection of a particular video asset causes an additional selection of an associated advertisement video.

14. A method for delivering video assets, comprising the steps of
providing a plurality of video assets representative of video content of the type capable of being displayed on a video player,
providing for respective ones of the video assets, metadata tracks representative of information about a respective video asset,
allowing a user to select from the plurality of video assets to identify a set of video assets to be joined sequentially into a composite video, and
processing the selected video assets as a function of their respective metadata tracks to generate a composite video having a metadata list panel that presents metadata information as video data appearing within a composite video that includes video data from the video asset, the sequence of video assets in the composite video being visually presented by the metadata list panel.

15. The method according to claim 14, further comprising
providing a plurality of advertisement videos representative of video content for promoting a good or service and being of the type capable of display on a video player, and
joining within the sequence of video assets in the composite video at least one advertisement video.

16. The method according to claim 15, further comprising
processing the selected video assets and the metadata to provide within the composite video a banner ad image.

17. The method according to claim 16, further comprising
serving banner ads for inclusion within the composite video.

18. The method according to claim 16, further comprising
serving targeted banner ads selected as a function of the metadata tracks associated with at least one of the selected video assets.

19. The method according to claim 15, further comprising
selecting the advertisement video as a function of the video assets selected.

20. The method according to claim 15, further comprising
selecting the advertisement video as a function of a subject associated with the selected video assets.

21. The method according to claim 15, further comprising
allowing a sponsor to provide the video assets and the advertisement videos.

22. The method according to claim 15, further comprising
generating a visual mark representative of a sponsor and applying the visual mark as an overlay on at least one of the selected video assets.

23. The method according to claim 15, further comprising
allowing a user to select the video assets for inclusion in the composite video.
